(19) United States
(12) Patent Application Publication
(10) Pub. No.: US 2016/0266751 A1
(43) Pub. Date: Sep. 15, 2016

(54) Virtualized Extended Desktop Workspaces

(71) Applicant: Lenovo (Singapore) Pte. Ltd., Singapore (SG)

(72) Inventors: Neal R. Caliendo, JR., Raleigh, NC (US); Russell S. VanBlon, Raleigh, NC (US); Arnold S. Weksler, Raleigh, NC (US)

(21) Appl. No.: 14/642,605

(22) Filed: Mar. 9, 2015

(51) Int. Cl. G06F 3/0484

(52) U.S. Cl. CPC G06F 3/0484

(57) ABSTRACT

An approach is provided to map virtual displays to physical displays that are accessible from an information handling system. When the number of attached physical displays changes, the approach detects the change and remaps the virtual displays to the changed number of physical displays.

### BACKGROUND

A portable computer (e.g., laptop, tablet, etc.) can extend its desktop work area across one or more external monitors. Although an extended desktop allows a single application window to be displayed across multiple monitors, users typically utilize each monitor as an individual workspace where they can drag and organize windows, program icons and other items within the extended desktop. However, when external monitors are disconnected from the computer, the desktop reverts to the computer's default internal display, and all windows, icons, etc. are moved so they remain visible to the user on the single internal display. Movement of all of the open windows, icons, and the like to a single internal display often over-crowds the internal display which is often a smaller laptop or tablet display. Current approaches provide multiple desktop features and some provide virtual changeable work areas to organize windows and icons. However, in these approaches, there is no association between logical desktops and physical display devices and the organization of windows and icons is not related to the available physical displays.

### SUMMARY

An approach is provided to map virtual displays to physical displays that are accessible from an information handling system. When the number of attached physical displays changes, the approach detects the change and remaps the virtual displays to the changed number of physical displays.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting changes to the number of physical displays attached to an information handling system and the resulting mapping of the virtual displays to the available physical displays;

FIG. 4 is a flowchart showing steps taken by a setup process;

FIG. 5 is a flowchart showing steps taken by a process that virtualizes extended desktop workspaces to available physical displays;

FIG. 6 is a flowchart showing steps taken by a virtual display manager that maps the virtual displays to the available physical displays based on user preferences; and

FIG. 7 is a flowchart showing steps taken by a process that swaps displays in order to display a user's preferred virtual displays on the available physical display.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

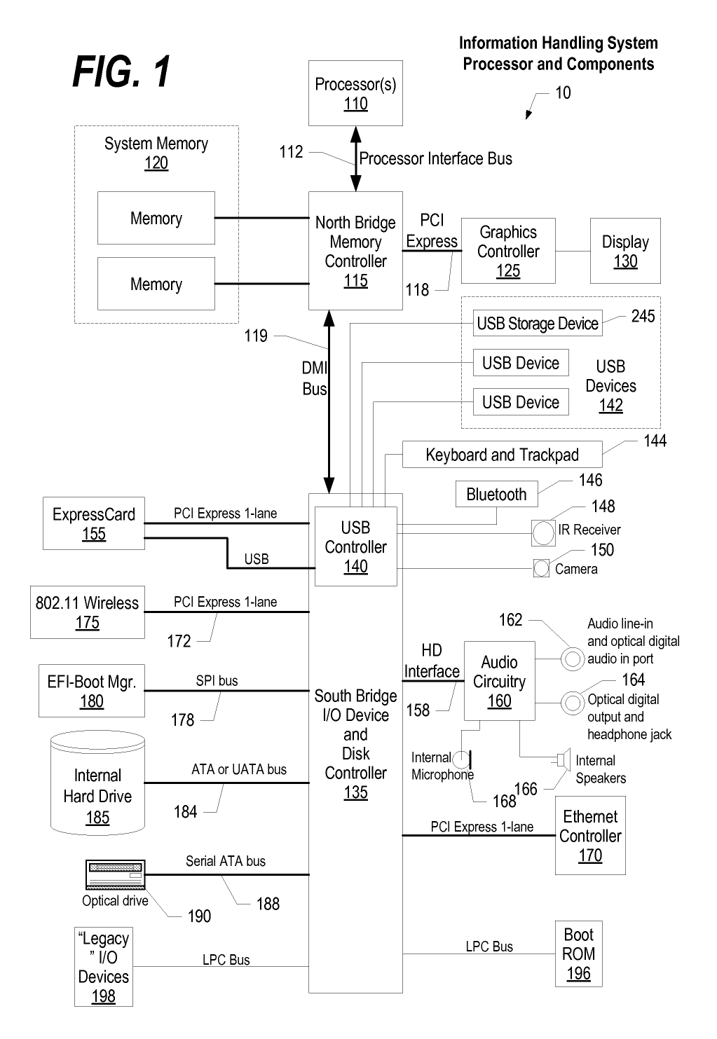

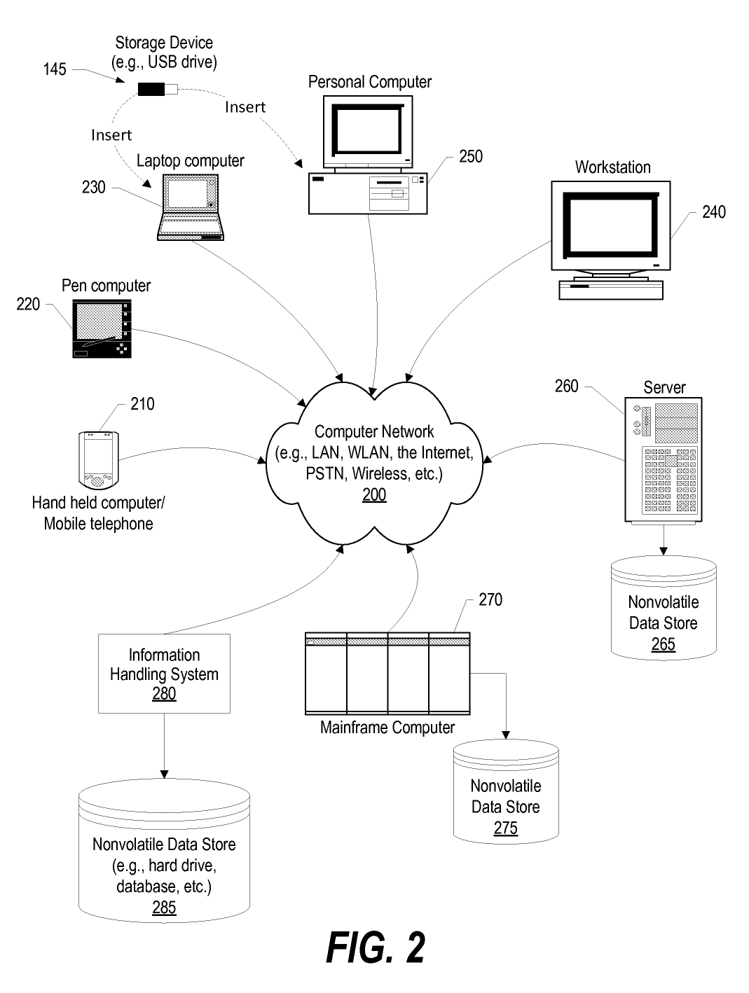

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

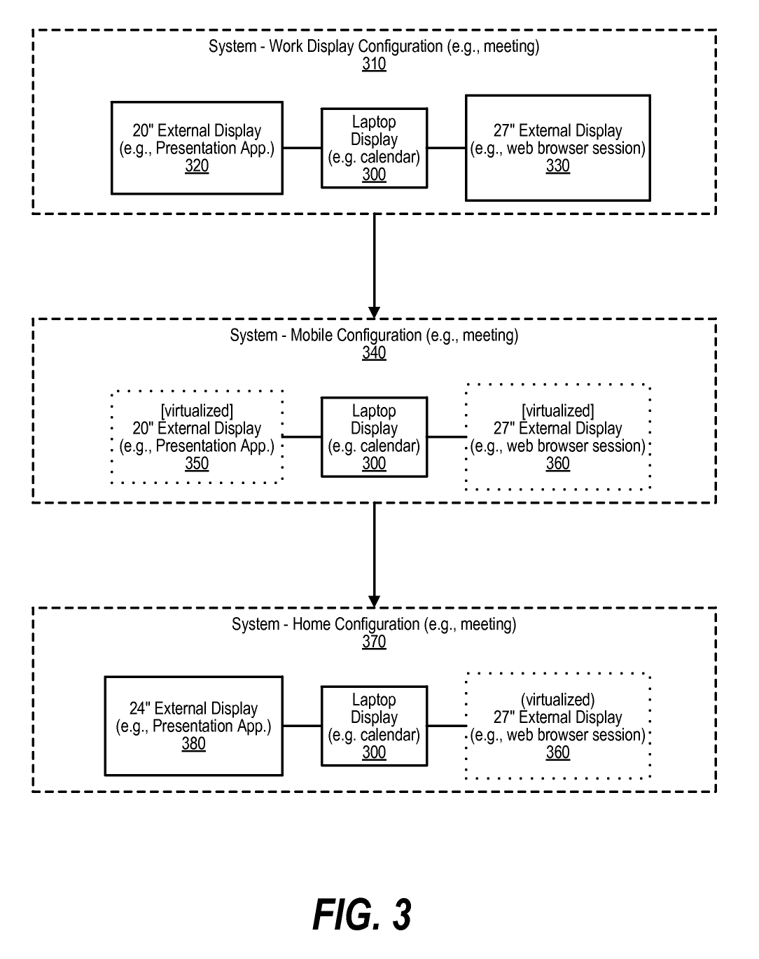

FIG. 3 is a diagram depicting changes to the number of physical displays attached to an information handling system and the resulting mapping of the virtual displays to the available physical displays. In the example shown, a user's laptop computer system is used with various physical displays available in different environments. Work display configuration 310 depicts the user's workplace environment where the user has laptop display 300, a 20 inch external display 320, and a 27 inch external display with laptop display 300 being included in the user's laptop computer system and the external displays being accessible to the laptop computer via a standard display interface (e.g., HDMI, SDI, DisplayPort, VGA, etc.). Based on the user's preference with the three accessible displays, when in workplace environment 310, such as in an online meeting configuration, laptop display 300 is used to display the user's calendar, 20″ display 320 is used to display a presentation application, and 27″ display 330 is used to display a web browser session. While, for simplicity, a single application is depicted as being displayed on an individual physical display, a configuration can be made to display multiple applications as part of a virtual display that are mapped to a physical display. For example, the configuration could be set to display the web browser and a word processor in a virtual display that is mapped to the 27″ display 330.

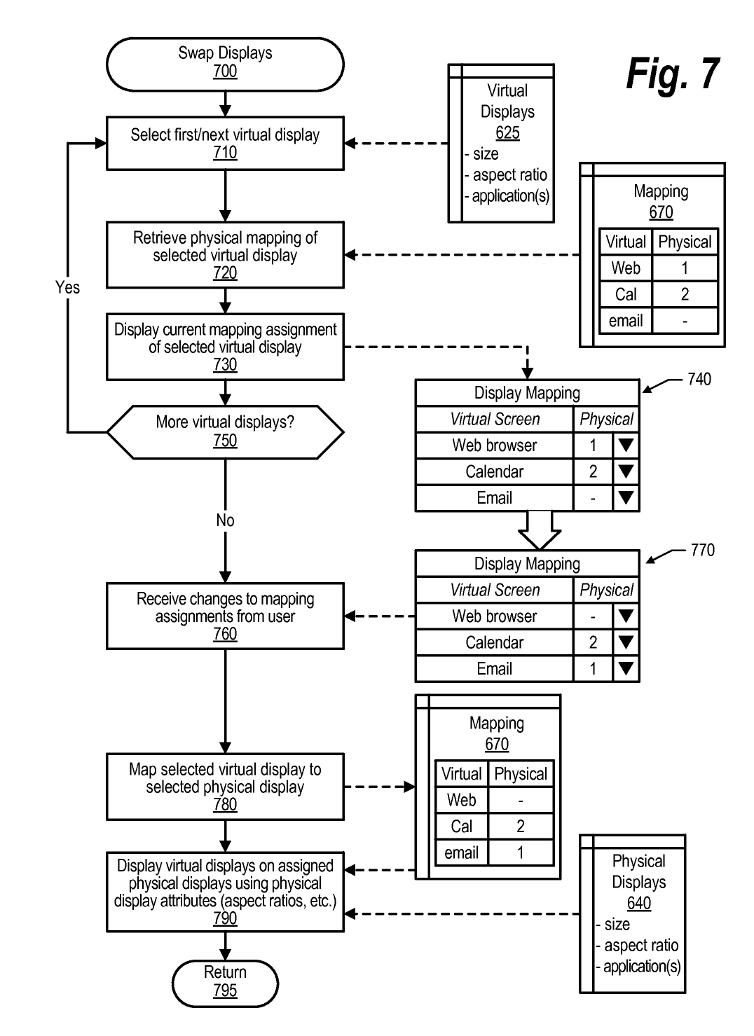

Environment 340 depicts a mobile computing environment, such as when the user disconnects 20″ display 320 and 27″ display 330 and takes the laptop on the road, such as to a coffee shop, airport, or the like. Here, the user has configured that the calendar application continue to be displayed on the laptop's display which is now the only display accessible to the laptop computer system. The sessions previously displayed on external displays 320 and 330 have now been virtualized as depicted by virtualized 20″ external display 350 and virtualized 27″ external display 360. The virtualized displays are used as containers for the presentation application and the web browser application. If the user wishes to view one of the virtualized displays on the laptop's display, as shown in FIG. 7, the user can swap displays to, in essence, display one of the virtualized displays on the laptop display and, at the same time, virtualize the calendar application. In this manner, the user can switch from one virtual display to another utilizing the single display provided by the laptop computer system. When virtual displays are remapped to a different physical display, display properties, such as aspect ratios, may be altered based on the size and other attributes of the physical display in relation to the attributes of the virtual display. For example, if the user swaps the web browser session from 27″ virtual display 380 to the smaller laptop display (e.g., 12″ display, etc.) the size of the web browser session and aspect ratios used on the laptop display may be altered in order to better display the web browser to the user in a more usable fashion.

Environment 370 depicts another configuration, such as a home configuration, that is used by the user. Here, the user has one external monitor, 24″ external display 380. This physical display is mapped to the virtual display in which the presentation application resides. Since this configuration only has two displays instead of three, the third virtual display (containing the web browser) remains virtualized in virtualized 27″ external display 360. Again, the user can swap displays in order to map virtual display 360 to either laptop display 300 or to 24″ external display 380 using the process that is shown in FIG. 7. A user-defined minimum aspect ratio is used to display the virtual display (the web browser) on one of the physical displays. When swapping to the 24″ physical display, little change may be needed to the visualization of the web browser since the 24″ display is only slightly smaller than the 27″ virtual display containing the web browser. However, if the web browser is swapped to the laptop display, the minimum aspect ratio may be reached and the virtual display may need to be resized or have horizontal/vertical scroll bars included to display the entire window in the smaller laptop display.

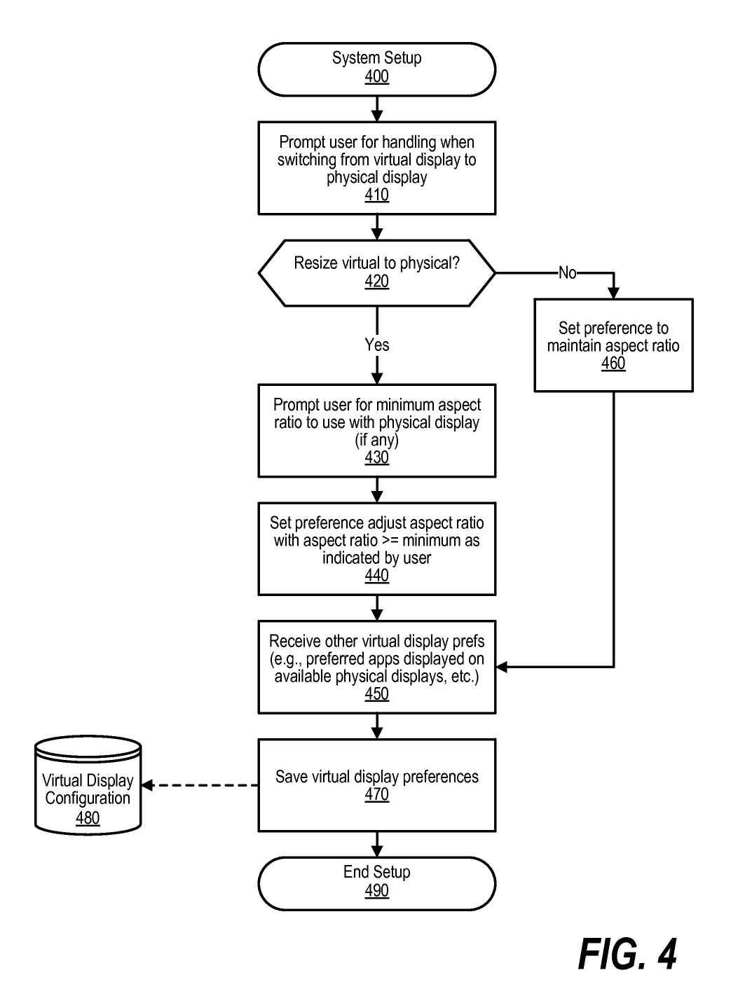

FIG. 4 is a flowchart showing steps taken by a setup process. FIG. 4 commences at 400 and shows the steps taken by a process that performs a setup routine that collects user preferences from the user. At step 410, the process prompts the user for handling instructions when switching from virtual display to physical display. The process determines as to whether the user wishes to resize the virtual display to the physical display using a different aspect ratio if necessary (decision 420). If the user wishes to resize the virtual display to the physical display using a different aspect ratio if necessary, then decision 420 branches to the ‘yes’ branch to perform steps 430 through 450. On the other hand, if the user does not wish to resize the virtual display to the physical display using a different aspect ratio when necessary, then decision 420 branches to the ‘no’ branch whereupon, at step 460, the process sets the user preference to maintain the same aspect ratio when switching from a virtual display to a physical display. Steps 430 through 450 are performed if the user wishes to resize the virtual display to the physical display using a different aspect ratio when necessary. At step 430, the process prompts the user for a minimum aspect ratio to use with a physical display. At step 440, the process sets the user's preference to adjust the aspect ratio so that the aspect ratio is always greater than or equal to the minimum ratio indicated by user. At step 450, the process receives other virtual display preferences such as preferred applications to display on available physical displays, etc. At step 470, the process saves the user's virtual display preferences to data store 480. Setup processing performed in FIG. 4 thereafter ends at 490.

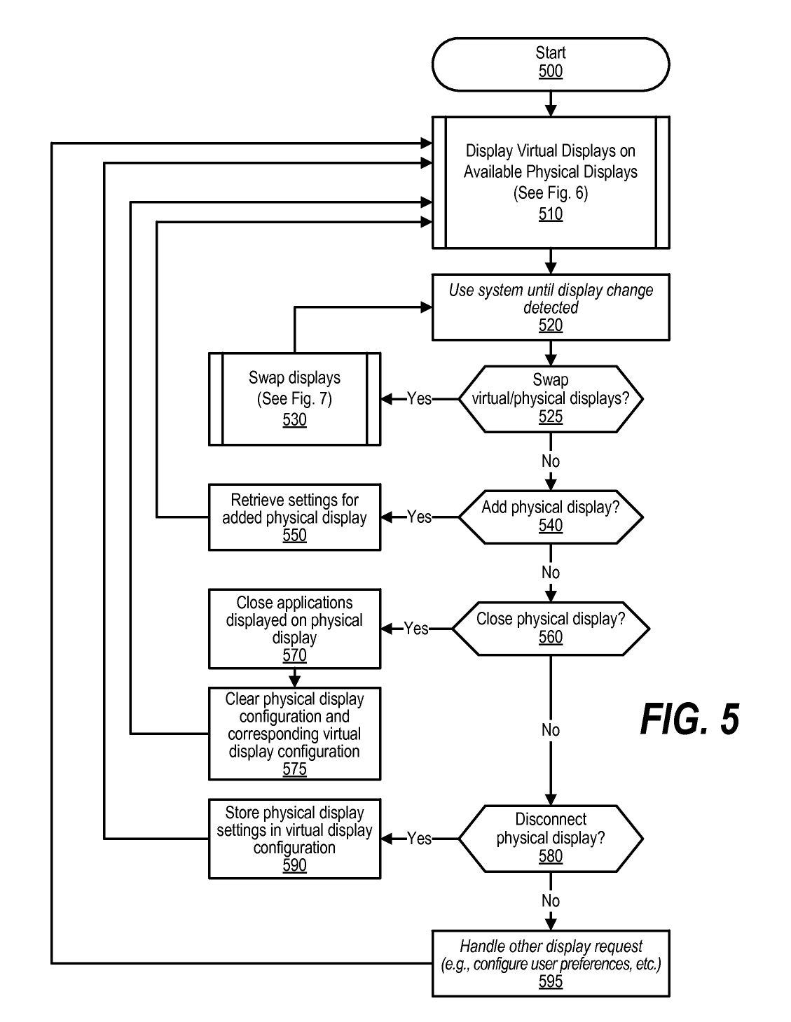

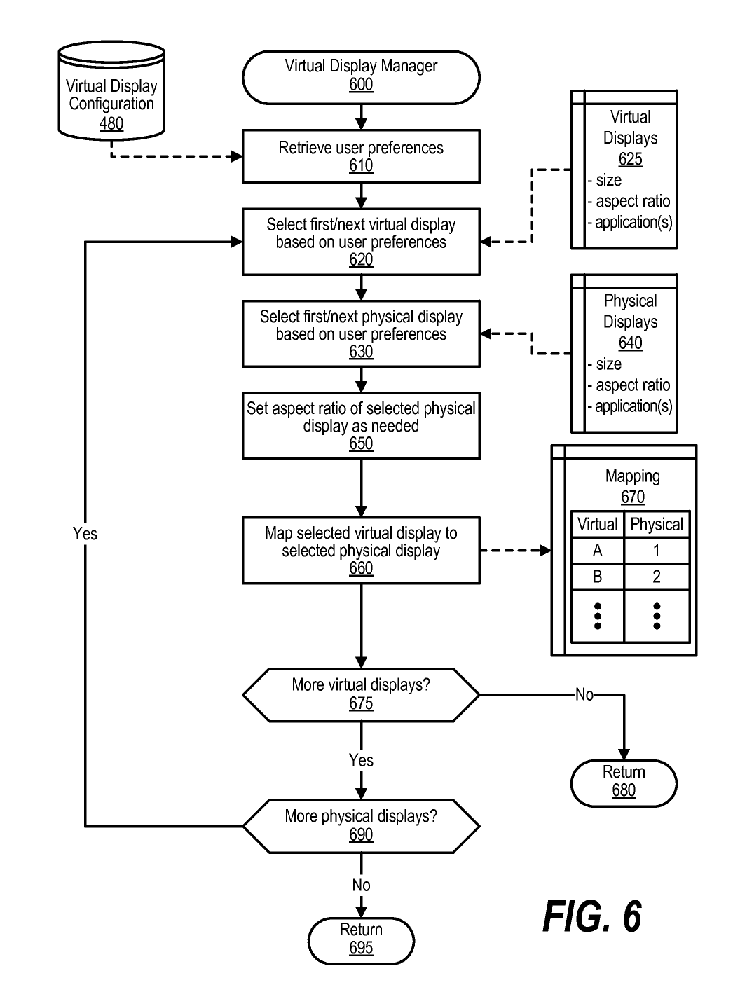

FIG. 5 is a flowchart showing steps taken by a process that virtualizes extended desktop workspaces to available physical displays. At step 500, the process performs a routine that virtualizes extended desktop workspaces to the available physical displays by virtualizing displays. At predefined process 510, the process performs the Display Virtual Displays on Available Physical Displays routine (see FIG. 6 and corresponding text for processing details). At step 520, the user uses the system with the number of physical displays attached until a change is detected in the number of physical displays available to the system.

The process determines as to whether to swap virtual/physical displays (decision 525), such as when a request is received from the user to swap displays so that a currently non-visible virtual display can be shown on an available physical display and the applications currently shown on the physical display are swapped out to a virtual (non-visible) display. If a swap of virtual/physical displays has been requested, then decision 525 branches to the ‘yes’ branch whereupon, at predefined process 530, the Swap Displays routine is performed (see FIG. 7 and corresponding text for details). Processing then loops back to step 520 with the user continuing to use the system with the virtual/physical displays now being switched.

On the other hand, a swap of virtual/physical displays has not been requested, then decision 525 branches to the ‘no’ branch for further evaluation. The process determines as to whether a physical display has been added to the system, such as when an external display is connected to the computer system using a cable (decision 540). If a physical display has been added to the system, then decision 540 branches to the ‘yes’ branch whereupon, at step 550, the process retrieves the settings for the physical display that has been added to the system (e.g., size, available aspect ratios, etc.). Processing then loops back to predefined process 510 that displays the virtual displays on the available physical displays after having the additional physical display added.

On the other hand, if a physical display has not been added to the system, then decision 540 branches to the ‘no’ branch for further evaluation. The process determines as to whether a physical display has been closed (decision 560). If close physical display, then decision 560 branches to the ‘yes’ branch to perform steps 570 and 575. At step 570, the process closes all applications currently being displayed on the physical display. At step 575, the process clears the physical display configuration and the corresponding virtual display configuration from the mapping tables. Processing then loops back to predefined process 510 that displays the virtual displays on the available physical displays after having the physical display closed.

On the other hand, if a physical display has not been closed, then decision 560 branches to the ‘no’ branch for further evaluation. The process determines as to whether a physical display has been disconnected from the system, such as when a cable to an external display has been disconnected from a port on the computer system (decision 580). If a physical display has been disconnected from the system, then decision 580 branches to the ‘yes’ branch, whereupon, at step 590, the process stores the physical display settings of the display that has been disconnected in virtual display configuration. Processing then loops back to predefined process 510 that displays the virtual displays on the available physical displays after having the additional physical display added.

On the other hand, a physical display has not been disconnected from the system, then decision 580 branches to the ‘no’ branch whereupon, at step 595, the process handles any other display requests, such as a request from the user to configure the user preferences as shown in FIG. 4, etc.).

FIG. 6 is a flowchart showing steps taken by a virtual display manager that maps the virtual displays to the available physical displays based on user preferences. FIG. 6 commences at 600 and shows the steps taken by a process that performs the virtual display manager routine that displays the virtual displays on the available physical displays.

At step 610, the process retrieves user preferences from configuration data store 480. At step 620, the process selects the first virtual display based on the retrieved user preferences. Step 620 retrieves the virtual display data from memory area 625 with the virtual display data including the size of the virtual display, the aspect ratio of the virtual display, and the application(s) and other graphical user interfaces (GUIs) displayed in the virtual display along with the positioning of such applications and GUIs in the virtual display. At step 630, the process selects the first physical display based on user preferences. Step 630 retrieves the physical display data from memory area 640 with the physical display data including the size of the physical display, the available and current aspect ratios of the physical display, and the applications and GUIs displayed in the physical display.

At step 650, the process sets the aspect ratio of the selected physical display as needed based on the virtual display and the user preferences regarding minimum aspect ratios desired by the user. At step 660, the process maps the selected virtual display to the selected physical display. Step 660 stores the mapping data in memory area 670.

The process determines as to whether there are more virtual displays to process (decision 675). If more virtual displays, then decision 675 branches to the ‘yes’ branch and processing continues. On the other hand, if there are no more virtual displays to process, then decision 675 branches to the ‘no’ branch and processing returns to the calling routine (see FIG. 5) at 680.

The process next determines as to whether there are more physical displays that can be utilized to display virtual displays (decision 690). If there are more physical displays that can be utilized to display virtual displays, then decision 690 branches to the ‘yes’ branch which loops back to select and process the next physical and virtual displays as described above. This looping continues until there are no more physical displays that can be utilized to display virtual displays, at which point decision 690 branches to the ‘no’ branch and processing returns to the calling routine (see FIG. 5) at 695.

FIG. 7 is a flowchart showing steps taken by a process that swaps displays in order to display a user's preferred virtual displays on the available physical display. FIG. 7 commences at 700 and shows the steps taken by a process that swaps virtual/physical displays.

At step 710, the process selects the first virtual display from virtual display memory area 625. At step 720, the process retrieves the physical mapping data of the selected virtual display from memory area 670. Note that some virtual displays may not be currently mapped to a physical display. In the example shown, the virtual display handling “email” is not currently mapped to a physical display. At step 730, the process displays the current mapping assignment of the selected virtual display in display mapping window 740.

The process determines as to whether there are more virtual displays to process (decision 750). If there are more virtual displays to process, then decision 750 branches to the ‘yes’ branch which loops back to select and process the next virtual display and display an entry for the virtual display in display window 740. This looping continues until there are no more virtual displays to process, at which point decision 750 branches to the ‘no’ branch for further processing.

At step 760, the process receives changes to mapping assignments from the user. In the example shown, the user has chosen to no longer map the “web browser” virtual display to a physical display and has instead mapped the “email” virtual display to the physical display that used to display the web browser. At step 780, the process maps the selected virtual displays to the selected physical displays. This mapping is reflected in changes to mapping memory area 670. At step 790, the process displays the virtual displays on the assigned physical displays using the physical display attributes (aspect ratios, etc.) that are received from memory area 640. FIG. 7 processing thereafter returns to the calling routine (see FIG. 5) at 795.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

What is claimed is:

1. A method comprising:
mapping one or more virtual displays to one or more physical displays accessible from an information handling system;
detecting a change to a number of the physical displays that are accessible from the information handling system; and
in response to detecting the change in the number of physical displays, remapping the virtual displays to the changed number of physical displays.

2. The method of claim 1 wherein each of the virtual displays is a container for one or more graphic user interfaces.

3. The method of claim 1 further comprising:
receiving a set of one or more user preferences, wherein the user preferences comprise at least one of a minimum aspect ratio to utilize for one or more of the physical displays, a preferred virtual display selected from the one or more virtual displays to display on a preferred physical display selected from the one or more physical displays, and wherein the mapping and remapping are performed based on the received set of user preferences.

4. The method of claim 3 wherein the detecting is an addition of one of the physical displays, and wherein the method further comprises:
retrieving one or more settings based on the user preferences, wherein the settings pertain to the added physical display; and
based on the retrieved settings, mapping one of the virtual displays to the added physical display.

5. The method of claim 3 wherein the detecting is a disconnection of one of the physical displays from the information handling system, and wherein the method further comprises:
storing one or more physical display settings as a virtual display configuration;
retrieving one or more settings based on the user preferences, wherein the settings pertain to the one or more physical display that remain attached to the information handling system following the disconnection; and
based on the retrieved settings, mapping the virtual displays to the one or more physical display that remain attached to the information handling system following the disconnection.

6. The method of claim 3 wherein the detecting is a closing of a selected one of the physical displays, and wherein the method further comprises:
closing one or more applications currently displayed on the selected physical display;
clearing a physical display configuration that pertains to the selected physical display; and
clearing a virtual display configuration that pertains to the selected physical display.

7. The method of claim 1 further comprising:
receiving a request to swap displays;
retrieving a current mapping of the virtual displays to the physical displays;
receiving a change to one or more mapping assignments included in the performing a second remapping that maps one or more of the virtual displays to the one or more physical displays based on the change to the mapping assignments; and
displaying the one or more virtual displays on the one or more physical displays using one or more user-specified physical display attributes that correspond to the one or more physical displays.

8. An information handling system comprising:
one or more processors;
a memory coupled to at least one of the processors; and
a set of instructions stored in the memory and executed by at least one of the processors to:
map one or more virtual displays to one or more physical displays accessible from an information handling system;
detect a change to a number of the physical displays that are accessible from the information handling system; and
in response to detecting the change in the number of physical displays, remap the virtual displays to the changed number of physical displays.

9. The information handling system of claim 8 wherein each of the virtual displays is a container for one or more graphic user interfaces, wherein the graphic user interfaces are selected from a group consisting of one or more windows and one or more icons.

10. The information handling system of claim 8 wherein the actions further comprise:
receive a set of one or more user preferences, wherein the user preferences comprise at least one of a minimum aspect ratio to utilize for one or more of the physical displays, a preferred virtual display selected from the one or more virtual displays to display on a preferred physical display selected from the one or more physical displays, and wherein the mapping and remapping are performed based on the received set of user preferences.

11. The information handling system of claim 10 wherein the detection is an addition of one of the physical displays, and wherein the actions further comprise:
retrieve one or more settings based on the user preferences, wherein the settings pertain to the added physical display; and
based on the retrieved settings, map one of the virtual displays to the added physical display.

12. The information handling system of claim 10 wherein the detection is a disconnection of one of the physical displays from the information handling system, and wherein the actions further comprise:
store one or more physical display settings as a virtual display configuration;
retrieve one or more settings based on the user preferences, wherein the settings pertain to the one or more physical display that remain attached to the information handling system following the disconnection; and
based on the retrieved settings, map the virtual displays to the one or more physical display that remain attached to the information handling system following the disconnection.

13. The information handling system of claim 10 wherein the detection is a closing of a selected one of the physical displays, and wherein the actions further comprise:
close one or more applications currently displayed on the selected physical display;
clear a physical display configuration that pertains to the selected physical display; and
clear a virtual display configuration that pertains to the selected physical display.

14. The information handling system of claim 8 wherein the actions further comprise:
receive a request to swap displays;
retrieve a current mapping of the virtual displays to the physical displays;
receive a change to one or more mapping assignments included in the current mapping;
perform a second remapping that maps one or more of the virtual displays to the one or more physical displays based on the change to the mapping assignments; and
display the one or more virtual displays on the one or more physical displays using one or more user-specified physical display attributes that correspond to the one or more physical displays.

15. A computer program product comprising:
a computer readable storage medium comprising a set of computer instructions, the computer instructions effective to:
map one or more virtual displays to one or more physical displays accessible from an information handling system;
detect a change to a number of the physical displays that are accessible from the information handling system; and
in response to detecting the change in the number of physical displays, remap the virtual displays to the changed number of physical displays.

16. The computer program product of claim 15 wherein the set of instructions further comprise instructions effective to:
receive a set of one or more user preferences, wherein the user preferences comprise at least one of a minimum aspect ratio to utilize for one or more of the physical displays, a preferred virtual display selected from the one or more virtual displays to display on a preferred physical display selected from the one or more physical displays, and wherein the mapping and remapping are performed based on the received set of user preferences.

17. The computer program product of claim 16 wherein the detection is an addition of one of the physical displays, and wherein the set of instructions further comprise instructions effective to:
retrieve one or more settings based on the user preferences, wherein the settings pertain to the added physical display; and
based on the retrieved settings, map one of the virtual displays to the added physical display.

18. The computer program product of claim 16 wherein the detection is a disconnection of one of the physical displays from the information handling system, and wherein the set of instructions further comprise instructions effective to:
store one or more physical display settings as a virtual display configuration;
retrieve one or more settings based on the user preferences, wherein the settings pertain to the one or more physical display that remain attached to the information handling system following the disconnection; and
based on the retrieved settings, map the virtual displays to the one or more physical display that remain attached to the information handling system following the disconnection.

19. The computer program product of claim 16 wherein the detection is a closing of a selected one of the physical displays, and wherein the set of instructions further comprise instructions effective to:
close one or more applications currently displayed on the selected physical display;
clear a physical display configuration that pertains to the selected physical display; and
clear a virtual display configuration that pertains to the selected physical display.

20. The computer program product of claim 15 wherein the set of instructions further comprise instructions effective to:
receive a request to swap displays;
retrieve a current mapping of the virtual displays to the physical displays;
receive a change to one or more mapping assignments included in the current mapping;
perform a second remapping that maps one or more of the virtual displays to the one or more physical displays based on the change to the mapping assignments; and
display the one or more virtual displays on the one or more physical displays using one or more user-specified physical display attributes that correspond to the one or more physical displays.
